(19) United States
(12) Patent Application Publication
(10) Pub. No.: US 2003/0206101 A1
(43) Pub. Date: Nov. 6, 2003

(54) The home answering system

(76) Inventors: Leonard Allen Dixon, Chicago, IL (US); Bianca Lynett Dixon, Chicago, IL (US)

Correspondence Address: Leonard and Bianca Dixon, 6910 South Dorchester, Chicago, IL, 60637, US

(21) Appl. No.: 10/098,253

(22) Filed: May 6, 2002

(51) Int. Cl. G08B 1/08

(52) U.S. Cl. 340/539.1; 340/691.1

(57) ABSTRACT

This new and unique system will revolutionize the way people answer their doors. It allows people to answer the door without having to physically go to it, from any room inside the home, or even from outside of the home.

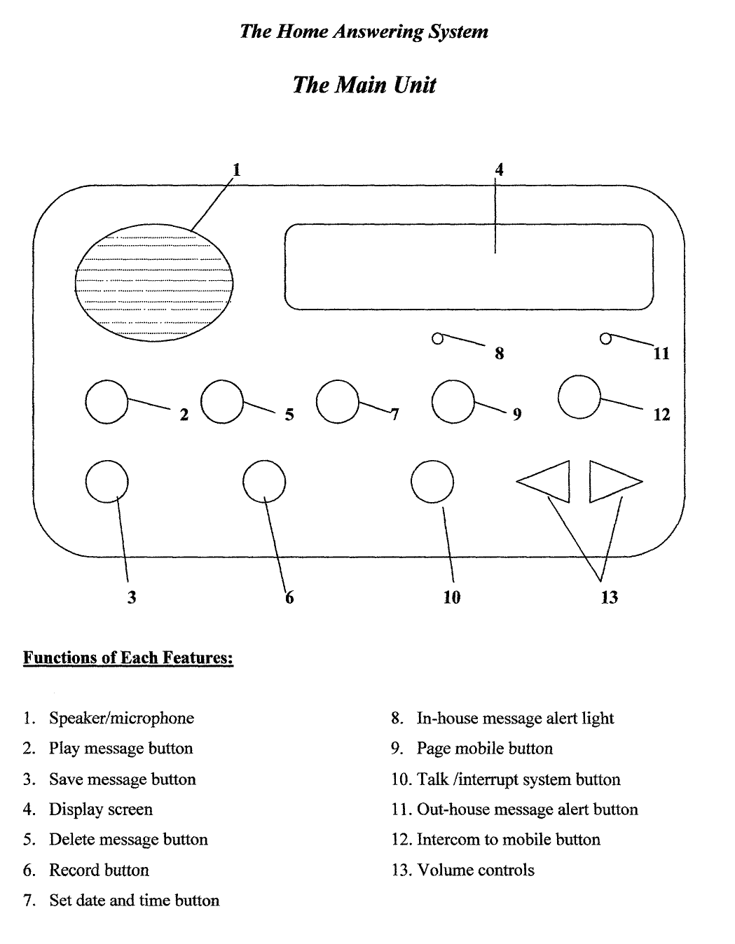

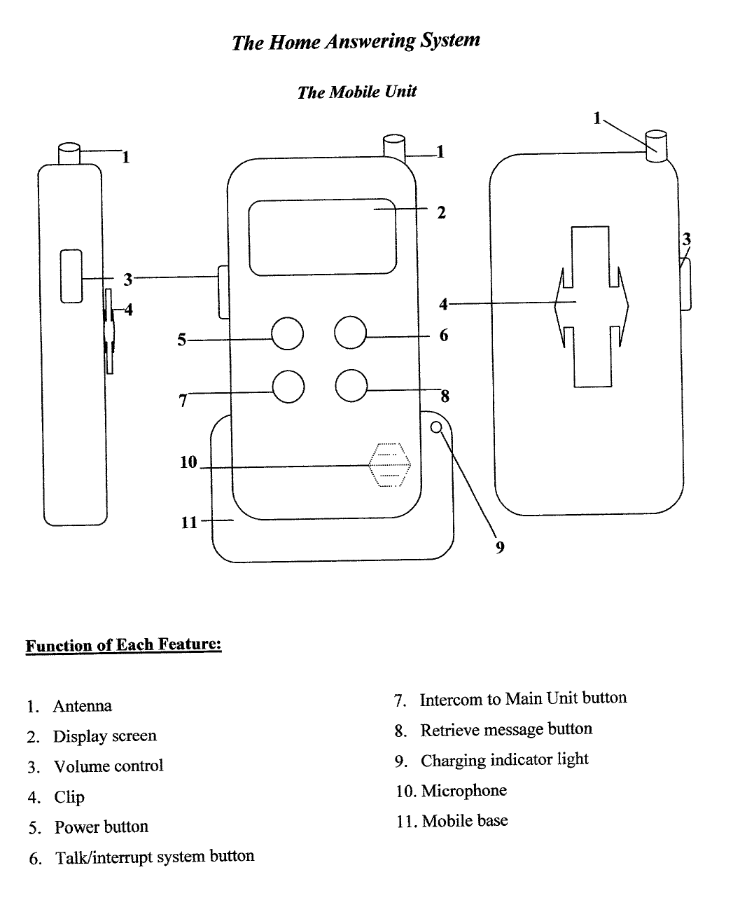

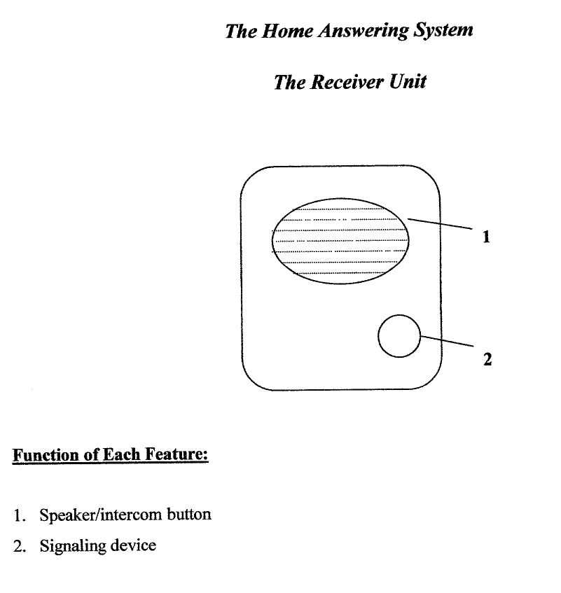

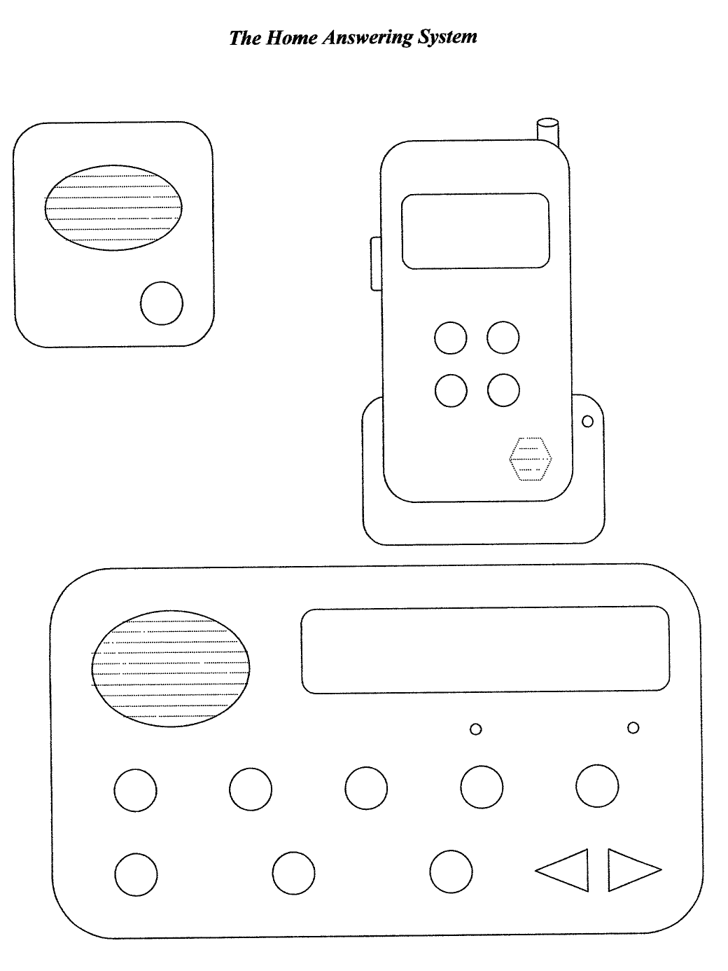

It consists of three parts, the Main, Mobile, and Receiver Units. Together they give you the comfort of allowing you to decide if you want to answer the door or let the system answer it for you. The system can be customized or play a pre-recorded prompt.

It can operate in various modes. System users can communicate with one another inside and outside of the hone. They can also leave messages for each other. Because it is unknown to the visitor whether you are at home or not, the system gives you the flexibility of being away for extended periods of time. When you are unavailable it takes the time and date of each message left by a visitor.

### BACKGROUND OF INVENTION

Leonard Dixon and Bianca Dixon invented the Home Answering System on Sep. 6, 1994. The Home Answering System consists of three parts. They are the Main Unit, the Mobile Unit, and the Receiver Unit. Each unit functions together offering a new and unique system that allows people to answer the door without having to physically go to it.

From any room inside your house or even outside your home, the Home Answering System allows you to answer the door. It displays the time and date. The Home Answering System gives you the comfort of allowing you to decide if you want to answer the door or let the system answer it for you. It gives you the capability of knowing who came to visit you, the time and date of their visit, and why, even when you are not at home.

The Home Answering System allows persons inside or outside of the house to speak to one another, The Home Answer System is able to operate in various modes to give you the flexibility of being away from your home for extended periods of time.

When a visitor presses the signaling device, the Home Answering System activates. It then plays a general recording (this can be customized) requesting the visitor to identify themselves. The visitor's response is then recorded and played aloud over the Main and Mobile Units. You can respond by interrupting from either the Main or Mobile Units and speak directly to the visitor.

If you are not home or choose not to respond simply let the system continue uninterrupted. After a specified amount of time, the Home Answering System will tell the visitor no one is available and ask him or her to leave an optional message. It next records the message. When returning home or checking for left messages, a light will alert you of unheard messages on the Main and Mobile Unit. The Home Answering System allows you to hear, delete, and save heard messages.

### BRIEF SUMMARY OF THE MAIN UNIT

Basic Function

The Main Unit is the principal unit of the Home Answering System. It can be installed anywhere in the home where there is an A/C current. The Main Unit is programmed with pre-recorded greetings and prompts, or the system owner can personalize them.

How It Works

This is how the Main Unit works:

When the signaling device rings, the Main Unit rings, alerting you that someone is at the door. The Main Unit next plays the specified greeting prompting the visitor to identify his or herself. If no response is given in a specified amount of time, the visitor is again prompted to identify his or herself. Failing to response after the repeated prompt, will cause the Main Unit to discontinue, alerting the visitor that their attempt has been unsuccessful and to try again.

When a response is given by the visitor, it is recorded and played aloud on both the Main and Mobile Units. To acknowledge the visitor, you may interrupt the Main Unit either at its base or from the Mobile Unit by pressing the TALK button and speak directly to the visitor.

When the visitor's response is played aloud over the Main and Mobile Units, you may wish to decline the visit. To do so, simply allow the Main Unit to play uninterrupted and it will tell the visitor you are unavailable and ask him or her to leave an optional message. The message is recorded along with the time and date of their visit. If the visitor fails to leave a message, the Main Unit will save the initially recorded response alerting you of their visit.

Features

Some of the Features of the Main Unit are:

1) Displays the time and date.

2) Records message along with the time and date left.

3) Allows home occupants to leave a message to one another.

4) The Main Unit alerts you when you have messages.

5) From the Main Unit you can retrieve unheard messages.

### BRIEF SUMMARY OF THE MAIN UNIT (continued)

Features

Some of the Features of the Main Unit are:

6) The Main Unit has volume control.

7) From the Main Unit you can page the Mobile Unit.

8) The Main Unit monitors the Mobile Unit, alerting you when its battery is low.

9) You may use the intercom to speak to the Mobile Unit.

10) The Main Unit alerts you when the Mobile Unit is out of range.

11) From the Main Unit you can delete or save heard messages.

12) From the Main Unit you can personalize greetings.

### BRIEF SUMMARY OF THE MOBILE UNIT

Basic Function

The Mobile Unit is separate from the Main Unit making it more convenient. It charges on its on stand, and can be plugged anywhere in the house where an A/C outlet is located. While the Mobile Unit is being charged, a light is lit on the mobile's stand to confirm charging. The Mobile Unit can be removed and can be carried or clipped on to one's clothing. It can be taken anywhere in the home. It can be taken outside. It works in the yard, garage, and around the outside of your home. All of these can be done within a specified radius of the Main Unit.

How It Works

This is how the Mobile Unit works: When the signaling device rings, the Mobile Unit rings, alerting you that someone at the door. The Receiver Unit will prompt the visitor, and the Main Unit will record their response. You will have the option to:

1) Press the POWER button to turn the mobile Unit on and listen in to the system. *(When the Mobile Unit is on its stand, it will automatically play aloud the system.)

2) After pressing the POWER button, listen in without interrupting the system.

3) Listen in and press the TALK button to respond to the visitor

4) Don't press the POWER button, and let the system automatically answer the door and take a message.

Features

Some of the Features of the Mobile Unit are:

1) The Mobile Unit has an intercom that can be used from the Main Unit to the Mobile Unit. (This will work even when the Mobile Unit is outdoors.)

2) From the Mobile Unit you can retrieve messages left by visitors.

3) The Mobile Unit has volume control.

4) If the Mobile Unit is misplaced, it can be paged from the Main Unit.

5) The Mobile Unit alerts you when you are out of the specified range.

6) The Mobile Unit alerts you will the battery is low.

### BRIEF SUMMARY OF THE RECEIVER UNIT

Basic Function

The Receiver Unit is located outside of the home or apartment. It consists of a signaling device and a two-way transmitter. The Receiver Unit is wired to the Main Unit, powered by an A/C current. The Receiver Unit initiates communication between the visitor and the Main Unit.

How It Works

This is how the Receiver Unit works: When a visitor comes to your door, they must press the signaling device. When the signaling device rings, the Main Unit rings, alerting you that someone is at the door. Through the Receiver Unit, the visitor hears a recording from the Main Unit prompting them to identify his or herself. The Main Unit will record the initial response given by the visitor. All communication processed the Receiver Unit.

Features

Some of the Features of the Receiver Unit are:

1) the receiver unit plays the recorded greeting to the visitor.

2) allows two-way communication between the visitor and the home answering system.

3) the receiver unit alerts you of a visitor.

1. We claim The Home Answering System consists of a Main Unit.
The Main Unit is installed anywhere in the home where there is an A/C current.
From the Main Unit you can set the Home Answering System on various modes.
It is programmed with pre-recorded greetings and prompts, or they can be personalized.
It displays the time and date.
The Main Unit rings will someone rings the signaling device.
The Main Unit allows you to interrupt the automated greeting and respond to the visitor.
The Main Unit records messages left by visitors along with the time and date that each message is left.
It also allows home occupants to leave recorded messages to one another.
From the Main Unit, you can personalize greetings.
From the Main Unit you can respond to visitors.
From the Main Unit you can retrieve all unheard messages along with the time and date they were left.
From the Main Unit you can delete or save messages.
From the Main Unit you can page the Mobile Unit.
From the Main Unit you can talk on the intercom to the Mobile Unit.
The Main Unit is equipped with volume control.
It alerts you of messages.
It alerts you when the Mobile Unit is out-of-range.
It alerts you when the Mobile Unit's battery is low.

2. We claim The Home Answering System consist of a Mobile Unit.
The Mobile Unit can be plugged anywhere in the home where there is an A/C outlet.
The Mobile Unit can be cut on or off.
It charges on its stand.
It is removable from its stand and can be carried or clipped on to one's clothing.
The Mobile Unit rings will someone rings the signaling device.
The Mobile Unit allows you to interrupt the automated greeting and respond to the visitor.
The Mobile Unit works throughout the home and within a specified radius outside the home.
The Mobile Unit allows you to respond to visitors from anywhere inside the home.
The Mobile Unit allows you to respond to visitors from outside the home (within a specify range).
From the Mobile Unit you can respond to visitors.
From the Mobile Unit you can retrieve messages left by visitors.
From the Mobile Unit you can page the Main Unit.
From the Mobile Unit you can talk on the intercom to the Main Unit.
The Mobile Unit has a volume control.
The Mobile Unit has an out-of-range alert.
The Mobile Unit has a low battery alert.

3. We claim The Home Answering System consist of the Receiver Unit.
The Receiver Unit is installed outside of the home or apartment.
The Receiver Unit is a signaling device and a two-way transmitter that is wired to the Main Unit powered by an A/C current.
The Receiver Unit initiates communication between visitors and the Main Unit.
The Receiver Unit initiates communication between visitors and the Mobile Unit.
The Receiver Unit alerts you of a visitor.
It plays the recorded greeting to the visitor.
It allows two-way communication between the visitor and the householder.
